(19) United States
(12) Patent Application Publication
(10) Pub. No.: US 2008/0309025 A1
(43) Pub. Date: Dec. 18, 2008

(54) HYBRID MOUNTING PROVIDING SEALING AND NVH FUNCTION FOR STRUCTURES

(75) Inventor: Eric Herrera, Plymouth, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/763,698

(22) Filed: Jun. 15, 2007

(51) Int. Cl. F16J 15/02

(52) U.S. Cl. 277/590

(57) ABSTRACT

A hybrid mounting system is provided for mounting components together with a gasket there between. The mounting system provides soft or hard mount bolt locations, depending on application, at areas identified as high frequency path or problem areas while hard or soft mount bolt connections, depending on application, are utilized at areas identified as non problem or path areas. The hybrid mounting system can be utilized in applications involving industrial machinery, automotive applications and other applications where two components are mounted together with a gasket there between.

### FIELD

The present disclosure relates to a hybrid mounting system for providing sealing and NVH function for assembled structures.

### BACKGROUND AND SUMMARY

Many types of industrial machinery, mechanisms and vehicles are often provided with components mating together with a gasket therebetween. These components can include engine components, housings, covers, and many other components. One concern with many types of machinery and vehicular components is the transmission of undesirable noises and vibrations.

Two methods are generally known for mounting components include utilizing “soft mounts” for mating components by utilizing vibration isolators at all bolt locations, and “hard mounts” for mating components utilizing no isolators at the bolt locations.

The present disclosure provides a hybrid mounting system for providing a sealing and NVH function for structures by combining both hard mount and soft mount bolt connections for mounting components together. With the hybrid mounting system of the present disclosure, the soft and hard mounts are located at predetermined NVH problem areas or NVH path areas that are identified for a particular application.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is partial cross-sectional view of a hybrid mounting system according to the principles of the present disclosure;

FIG. 2 is a perspective view of the hybrid mounting system according to the principles of the present disclosure; and

FIG. 3 is a schematic illustration of both a high frequency path or problem area and a no problem or path area of a component mounting system.

### DETAILED DESCRIPTION

The following description is merely exemplary in nature and is not intended to limit the present disclosure, application, or uses. It should be understood that throughout the drawings, corresponding reference numerals indicate like or corresponding parts and features.

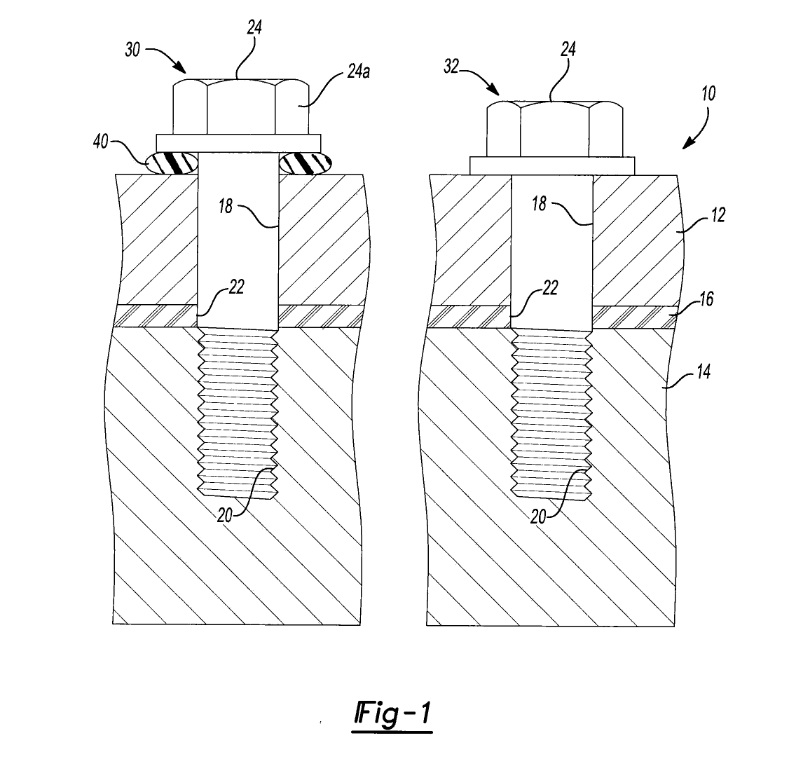

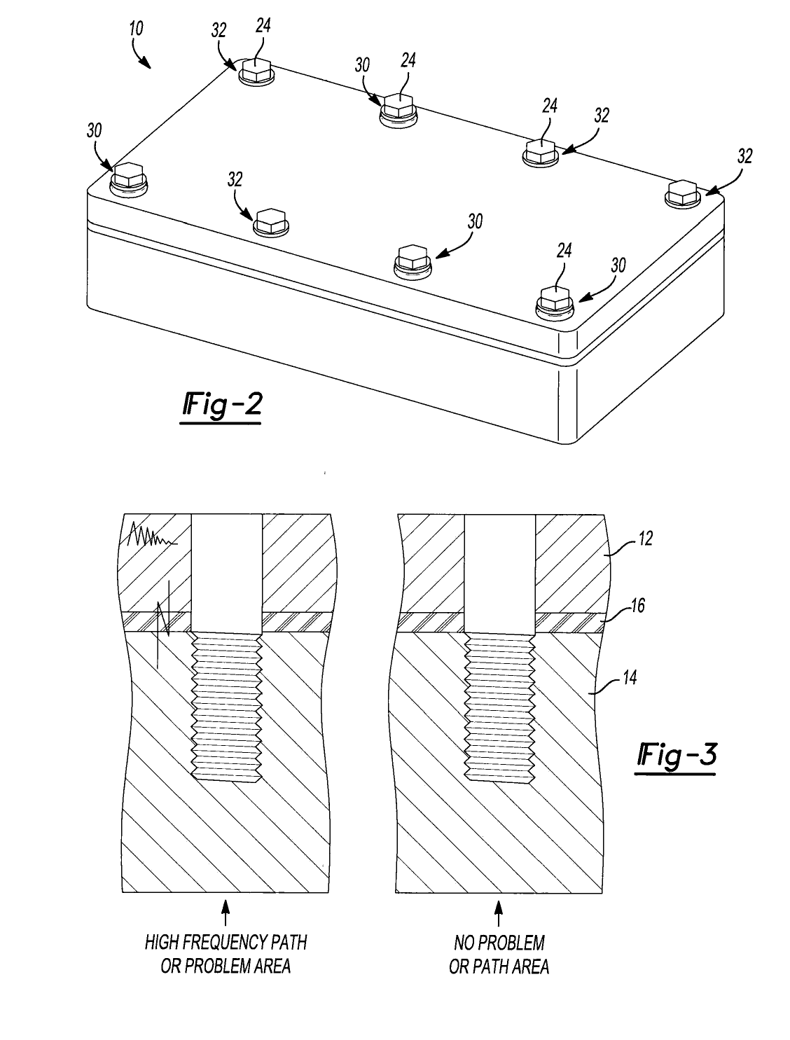

With reference to FIGS. 1 and 2, a component mounting system 10 according to the principles of the present disclosure will now be described. The component mounting system 10 is intended to represent a generic component system that can be representative of many types of components of machinery including industrial machinery, vehicular components such as engines, transmission, transfer cases and other applications where two components are mounted together utilizing a gasket therebetween. In the illustration of FIGS. 1 and 2, the mounting system 10 includes a first component 12 mounted to a second component 14 having a gasket 16 disposed there between.

The first component 12 includes a plurality of bolt holes 18 extending there through. The second component includes a plurality of bolt holes 20 therein that can be internally threaded or can alternatively extend all the way through the second component. The gasket 16 includes a plurality of bolt holes 22 extending there through. A plurality of mounting bolts 24 are provided for insertion into the bolt holes 18, 20, 22 for securing the first component 12 to the second component 14.

As illustrated in FIG. 3, the components 12, 14 can define areas of high frequency transmission there between and areas of low frequency transmission there between. As used herein the terms “high frequency” and “low frequency” are relative terms that can be determined based upon a specific application and the desired NVH characteristics. In other words, the threshold value for determining high and low frequency characteristic can vary from one application to another and cannot necessarily be determined based upon a single value for all applications. One method of identifying the relatively low frequency and high frequency portions of a component mounting system would be to identify an energy signature for the mating component in order to obtain a base line frequency for the system as a whole. From that base line frequency, localized frequencies that exceed that base line, or exceed that base line by a pre-determined amount can be identified as a “high frequency” localized area and those localized areas that are below the pre-determined frequency or below it by a pre-determined amount can be identified as “low frequency” localized areas.

According to the principles of the present disclosure, the localized areas that are determined to be high frequency problem areas or high frequency path areas are provided with a soft or hard mount bolt connection, depending upon the NVH parameters presented in a specific application, such as disclosed at 30 or 32 respectively. Whereas the determined low frequency areas are provided with a hard or soft mount bolt connection, depending upon the NVH parameters presented in the specific application, as illustrated at 32 or 30 respectively. By way of example, as illustrated in FIG. 2, the mounting system can be provided with a plurality of soft mount bolt locations 30 and a plurality of hard mount bolt locations 32, which can be determined based upon the methodology as described above or by other methodologies. Thus, with the system of present disclosure, the use of soft mounts is provided in areas which specifically would benefit from the soft mount characteristics, while hard mounts are utilized in areas where soft mounts would be less or no benefit and in areas which specifically would benefit from the hard mount characteristics. Therefore, the added cost of unnecessary soft mounts can be eliminated and the overall sealing and NVH characteristics of the mounting system can be improved.

In the present application, an exemplary soft mount bolt connection 30 is illustrated in FIG. 1 and includes an annular elastomeric grommet 40 disposed between the first component 12 and a head 24A of bolt 24. It should be understood that various other forms of soft mounts including soft mount features incorporated into the gasket, could also be utilized in combination with hard mounts to achieve the desired results of the present disclosure.

What is claimed is:

1. A component mounting system, comprising:
a first component having a first plurality of bolt holes therein;
a second component having a second plurality of bolt holes therein;
a gasket disposed between said first component and said second component and having a third plurality of bolt holes therein in alignment with respective ones of said first and second plurality of bolt holes; and
a plurality of bolts inserted in respective ones of said first, second and third bolt holes for securing said first and second components together, at least one of said plurality of bolts defining a soft mount and at least one of said plurality of bolts defining a hard mount, wherein said at least one of said plurality of bolts defining a soft mount is located at a location corresponding with an NVH path or problem area.

2. The component mounting system according to claim 1, wherein said at least one bolt defining a soft mount includes an elastomeric grommet disposed between a head of said at least one bolt and said first component.

3. The component mounting system according to claim 2, wherein said at least one bolt defining a hard mount includes a head portion disposed directly against said first component.

4. A method of sealingly mounting a first component to a second component for improved vibration characteristics, said method comprising:
determining one or more vibration path problem areas between said first component and said second component and determining one or more vibration path non-problem area between said first component and said second component;
mounting said first component to said second component with a gasket disposed there between;
inserting a plurality of bolts into said first and second components, said bolts located at said determined vibration path problem areas defining a soft mount and said bolts located at said determined non-problem areas defining a hard mount.

5. The method according to claim 4, wherein said bolts defining a soft mount include an elastomeric grommet disposed between a head of said bolt and said first component.

6. The method according to claim 5, wherein said bolts defining a hard mount include a head portion disposed directly against said first component.
